(19) United States
(12) Patent Application Publication
(10) Pub. No.: US 2022/0167482 A1
(43) Pub. Date: May 26, 2022

(54) SYSTEMS AND METHODS FOR LIGHTING MONITORING

(71) Applicant: Delos Living LLC, New York, NY (US)

(72) Inventors: Chuan HE, Bellevue, WA (US); Yiwen DI, Shanghai (CN)

(21) Appl. No.: 17/442,460

(22) PCT Filed: Mar. 20, 2020
(86) PCT No.: PCT/US20/23927

§ 371 Date: Sep. 23, 2021

Related U.S. Application Data
(60) Provisional application No. 62/823,439, filed on Mar. 25, 2019.

(51) Int. Cl. H05B 47/115; H05B 47/11

(52) U.S. Cl. CPC H05B 47/115; H05B 47/11

(57) ABSTRACT

Systems, methods, and apparatus are provided for monitoring and improving lighting in single- and multi-zone habitable environments. The lighting monitoring system includes a built structure, a central control circuit, a lighting control system, an environment database, an electronic user device, and light sensor arrays which are installed within the built structure. To facilitate the sensor installation process, the built structure may be delineated into one or more zones. The central control circuit may be configured to instruct the installation of light sensor arrays in particular zones within the built structure to obtain improved or even optimal or near optimal light sensor array placement.

### CROSS-REFERENCE TO RELATED APPLICATIONS

This application claims the benefit of U.S. Provisional Application No. 62/823,439, filed Mar. 25, 2019, which is incorporated herein by reference in its entirety.

### TECHNICAL FIELD

This invention relates generally to assessing, monitoring, and improving various lighting parameters in a habitable environment and/or spaces therein.

### BACKGROUND

Most people spend significant amounts of time in habitable environments, such as enclosed or partially enclosed spaces associated with homes, apartments, condominium units, hotel suites or rooms, motel suites or rooms, spas, hospitals, offices, schools, work spaces, and other public and private facilities. Sometimes these spaces are controlled, or even owned by, the principal occupants, such as homes, apartments, or condominium units. Other times these enclosed spaces are controlled by others, for example a facility owner or operator who may own and/or operate a hotel, motel, spa, hospital, or office.

Significant time in these spaces exposes the occupant to a wide range of environmental factors, any of which may have either adverse or beneficial effects on the occupant's health, well-being or sense of well-being. For example, poor lighting in a habitable environment has been linked to numerous short- and long-term health issues. Short-term effects of poor lighting may include, for example, sleep, gastrointestinal, mood, and cardiovascular disorders. Long-term effects may include, for example, eye disease, such as cornea damage or cataracts, and even skin cancer. Sick Building Syndrome (SBS) is a condition associated with increased time spent in buildings, and lighting in the habitable environment is thought to be a major contributing factor.

New approaches for monitoring and improving one or more lighting parameters (also referred to as illumination parameters) in one or more indoor or partially enclosed spaces within habitable environments are desirable.

### BRIEF SUMMARY

Generally speaking, pursuant to various embodiments, systems, apparatuses and methods are provided herein useful to improve lighting within a particular indoor or partially enclosed space or other habitable environments. Such spaces may include, for example, an office building, building office, open, partially open, or compartmentalized work or collaboration area, school, school room, apartment building, dormitory, single family home, multi-family dwelling or building, townhouse, theatre, train or bus station, library, public lounge, store or market, bakery, restaurant, tavern, pub, resort, bar, hostel, lodge, hotel, motel, inn, guest house, mall, art gallery, art studio, craft studio, ship, boat, gym, spa, fitness center, sports facility, gas station, airplane, airport, automobile, train, bus, kiosk, hospital, doctor's office, dentist's office, police station, fire station, lighthouse, bank, coffee shop, dry cleaner, department store, pharmacy, hardware store, drug store, grocery store, institution, music studio, recording studio, concert hall, radio station or studio, television station or studio, post office, church, mosque, synagogue, chapel, mobile home, barn, farm house, silo, residence, assisted living center, hospice, dwelling, laundromat, museum, hair salon, parking structure or facility, greenhouse, nursery, nail salon, barbershop, trailer, warehouse, storage facility, rest home, day care facility, laboratory, military facility, and any other place or facility where one or more people may congregate, live, work, meet, engage, spend time, etc. Within such spaces, there may be one or more sub-spaces or habitable environments that may be used for single or multiple purposes, such as home or other offices, kitchens, galleys, pantries, cooking areas, eating areas, home or office libraries or studies, conference rooms, dining rooms, bathrooms, toilets, powder rooms, play rooms, bedrooms, foyers, reception areas, file rooms, pods, pet rooms, storage rooms, junk rooms, carports, dens, basements, attics, garages, closets, classrooms, cabins, cabooses, train cars, bunk rooms, media rooms, baths, auditoriums, locker rooms, changing rooms, engine rooms, cockpits, work rooms, stairwells, exhibition rooms, platforms, elevators, walk ways, hallways, pools, stock rooms, exercise rooms, break rooms, snack rooms, living or family rooms, dressing rooms, slumber rooms, meeting rooms, conference rooms, offices, game rooms, porches, patios, seating areas, clean rooms, common rooms, lunch rooms, sky boxes, stages, prop rooms, make up rooms, safes, vaults, reception areas, check-in areas, compartments, drafting rooms, drawing rooms, computer or information technology rooms, waiting rooms, operating rooms, examination rooms, therapy rooms, emergency rooms, recovery rooms, machine rooms, equipment rooms, control rooms, laboratory rooms, monitoring rooms, and enclosed or partially enclosed areas, among others.

Occupants or other users, managers, or owners of such spaces or sub-spaces (i.e., zones) may want to control or influence the lighting parameters within a given space or sub-space, which may be, or may be part, of a habitable environment or other habitable, usable or occupiable area.

In one illustrative approach, an apparatus for sheltering occupants may be described as comprising a built structure having an indoor or partially enclosed environment, a plurality of light sensor arrays, and a central control circuit. The light sensor arrays are configured to measure one or more lighting parameters and are communicatively coupled to the central control circuit. The central control circuit is configured to delineate a plurality of functional zones in a built structure based on an electronic floor plan; after delineation of the functional zones, delineate each functional zone into daylight zones based on daylight distribution; identify a number of occupants on each view direction in each daylight zone; determine a minimum number of light sensor arrays required for open office daylight zones based on spatial requirements of the light sensor arrays and the number of occupants on each view direction in each daylight zone; and instruct the installation of at least one light sensor array in the delineated open office zones. If the total number of light sensor arrays available for installation is less than a sum of the minimum number of light sensor arrays required for the open office daylight zones, then the installation of light sensor arrays occurs based on an identified order of preference.

In another illustrative approach, a method for monitoring lighting parameters in a habitable environment may be summarized as delineating a plurality of functional zones in a built structure based on an electronic floor plan; delineating each functional zone into daylight zones based on daylight distribution; determining a minimum number of light sensor arrays required for open office daylight zones based on spatial requirements of the light sensor arrays and a number of occupants on each view direction in each daylight zone; instructing the installation of at least one light sensor array in at least one of the delineated open office daylight zones; and operating an lighting system according to readings from the light sensor arrays in the delineated functional zones. If a total number of light sensor arrays available for installation is less than a sum of the minimum number of light sensor arrays required for the open office daylight zones, then the installation of light sensor arrays occurs based on an identified order of preference.

In another illustrative approach, a system for monitoring lighting parameters in a habitable environment may be summarized as including a built structure having a plurality of functional zones, at least one light sensor array configured to measure one or more lighting parameters, a lighting control system associated with the built structure, at least one electronic user device associated with a user, and a control circuit. The lighting control system is configured to adjust at least one of lighting levels in at least a portion of the built structure. The control circuit is in communication with the light sensor array and the electronic user device. Further, the control circuit is configured to detect a particular occupant having an occupant profile in a lighting database; locate the particular occupant in a particular functional zone; analyze light sensor readings in the particular functional zone; compare the light sensor readings in the particular functional zone with parameters of the occupant profile associated with the particular occupant; and, upon detection that the light sensor readings in the particular functional zone are not within the lighting parameters of the occupant profile, instruct the lighting control system to adjust the lighting parameters pursuant to the occupant profile.

In some embodiments, the functional zones in the system for monitoring lighting parameters are delineated into one or more over-lighted zone, useful daylight zone, and electric light zone.

In another illustrative approach, a method for monitoring lighting parameters in a habitable environment may be summarized as receiving data from a plurality of sensor arrays in a space, wherein the space includes a plurality of zones. In the method, the plurality of light sensor arrays were positioned in the space by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In some embodiments, the method for monitoring lighting parameters in a habitable environment may further comprise determining if lighting levels within at least one of the plurality of zones needs to be adjusted and operating a lighting system to control lighting levels within the built structure.

In another illustrative approach, a method for monitoring lighting parameters in a habitable environment may be summarized as obtaining data from a plurality of light sensor arrays in a space, wherein the space includes a plurality of zones and determining, based at least in part on the data, if lighting levels within at least one of the plurality of zones needs to be adjusted. In the method, the plurality of light sensor arrays were previously positioned in the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In some embodiments, the method for monitoring lighting parameters in a habitable environment may further comprise operating a lighting system to control lighting levels within the built structure.

In another illustrative approach, a method for monitoring lighting parameters in a habitable environment may be summarized as obtaining data created by a plurality of light sensor arrays in a space that includes a plurality of zones and determining, based at least in part on the data, if lighting levels within at least one of the plurality of zones needs to be adjusted. In the method, the plurality of light sensor arrays were previously positioned in the space by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In some embodiments, the method for monitoring lighting parameters may further comprise operating a lighting system to control lighting levels within the built structure.

In another illustrative approach, a method for monitoring lighting parameters in a habitable environment may be summarized as determining if data generated by at least one light sensor array located in one of a plurality of zones indicates that one or more lighting parameters within the one of the plurality of zones should be adjusted. In the method, at least one light sensor array was positioned within at least one of the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In another illustrative approach, a method for monitoring lighting parameters in a habitable environment may be summarized as receiving an indicator of data generated by at least one light sensor array located in one of a plurality of zones that indicates that one or more lighting parameters within the one of the plurality of zones should be adjusted and operating an lighting system. In the method, at least one light sensor array is positioned within one of the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In another illustrative approach, a method for monitoring lighting parameters in a habitable environment may be summarized as receiving an indicator that one or more lighting parameters within at least one of a plurality of zones should be adjusted and operating a lighting system. In the method, the indicator that one or more lighting parameters should be adjusted is based on at least one reading made by at least one light sensor array. Further, in the method, at least one light sensor array is positioned within at least one of the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In another illustrative approach, a method for monitoring lighting parameters in a habitable environment may be summarized as receiving an indicator of data generated by at least one light sensor array positioned in one of a plurality of zones that indicates that air within the one of the plurality of zones meets a requirement for adjustment and operating a lighting system. Further, in the method, at least one light sensor array is positioned within one of the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In another illustrative approach, a method for monitoring lighting parameters in a habitable environment may be summarized as determining that light within one of a plurality of zones meets a threshold for adjustment and sending a signal indicative of the need for lighting parameter adjustment within the one of the plurality of zones. In the method, the threshold for adjustment is based on at least one lighting parameter measured by at least one light sensor array positioned in the one of the plurality of zones. Further, in the method, at least one light sensor array is positioned within one of the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In one illustrative approach, a method for monitoring lighting parameters in a habitable environment may be summarized as monitoring a plurality of light sensor arrays, each of the plurality of light sensor arrays being located within at least one of a plurality of zones and sending a signal indicative of the need for lighting parameter adjustment within the one of the plurality of zones. In the method, each of the plurality of light sensor arrays is positioned within the plurality of zones by delineating a plurality of functional zones in a built structure based on an electronic floor plan; delineating each functional zone into daylight zones based on daylight distribution; determining a minimum number of light sensor arrays required for the open office daylight zones based on spatial requirements of the light sensor arrays and a number of occupants on each view direction in each daylight zone; and instructing the installation of at least one light sensor array in at least one of the delineated open office daylight zones. If the total number of light sensor arrays available for installation was less than a sum of the minimum number of light sensor arrays required for the open office daylight zones, then the installation of light sensor arrays occurred on the basis of the following order of preference: areas having the highest total average daily occupied time first, then areas where the light sensor arrays cover the most occupants, and then areas where the light sensor arrays cover the most zones.

In one illustrative approach, an apparatus for sheltering occupants may be described as comprising a built structure having an indoor or partially enclosed environment, a light sensor array configured to measure one or more lighting parameters, and a central control circuit. The central control circuit is communicatively coupled to the light sensor array. Further, the central control circuit is configured to delineate a plurality of functional zones in a built structure based on an electronic floor plan; delineate each functional zone into daylight zones based on daylight distribution; determine a minimum number of light sensor arrays required for the open office daylight zones based on spatial requirements of the light sensor arrays and a number of occupants on each view direction in each daylight zone; and instruct the installation of at least one light sensor array in at least one of the delineated open office daylight zones. If a total number of light sensor arrays available for installation is less than a sum of the minimum number of light sensor arrays required for the open office daylight zones, then the installation of light sensor arrays occurs on the basis of the following order of preference: areas having the highest total average daily occupied time first, then areas where the light sensor arrays cover the most occupants, and then areas where the light sensor arrays cover the most zones

### BRIEF DESCRIPTION OF THE DRAWINGS

Disclosed herein are embodiments of systems, apparatuses and methods pertaining to assessing, monitoring, and improving the lighting in a habitable environment and/or spaces therein. In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn are not intended to convey any information regarding the actual shape of the particular elements and have been solely selected for ease of recognition in the drawings. Certain actions and/or steps may be described or depicted in a particular order of occurrence while those skilled in the art will understand that such specificity with respect to sequence is not actually required.

FIG. 1 is a block diagram of a system for monitoring one or more lighting parameters in a built structure in accordance with some embodiments.

FIG. 2 is a schematic diagram of daylight zones, identified by computer simulation, in a functional zone in accordance with some embodiments.

FIG. 3 is schematic diagram of possible view directions in a built structure in accordance with some embodiments.

FIG. 4 is a schematic diagram of daylight zones in functional zone in accordance with some embodiments.

FIGS. 5A and 5B are exemplary schematic diagrams of combined useful daylight zones and over-lighted zones.

FIG. 6 is flow diagram of a method for monitoring one or more lighting parameters in accordance with some embodiments.

FIG. 7 is schematic diagram of the view direction of a light sensor array in accordance with some embodiments.

FIGS. 8A, 8B and 8C are schematic diagrams of an exemplary habitable environment in which light sensor arrays sensors have been installed in accordance with several embodiments.

### DETAILED DESCRIPTION

In the following description, certain specific details are set forth in order to provide a thorough understanding of various disclosed embodiments. However, one skilled in the relevant art will recognize that embodiments may be practiced without one or more of these specific details, or with other methods, components, materials, etc. In other instances, well-known structures associated with lighting control systems such as computing systems, as well as networks and other communications channels have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open, inclusive sense, that is, as “including, but not limited to.”

As used in this specification and the appended claims, the singular forms “a,” “an,” and “the” include plural referents unless the content clearly dictates otherwise. It should also be noted that the term “or” is generally employed in its sense including “and/or” unless the content clearly dictates otherwise.

Reference throughout this specification to “one embodiment” or “an embodiment” means that a particular feature, structure or characteristic described in connection with the embodiment is included in at least one embodiment. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

The devices, systems, and methods described herein enable a user to monitor one or more lighting parameters in an indoor or partially enclosed space or other habitable environments. The indoor space, for example, may be a space within a built structure. Other habitable environments may include open or partially enclosed spaces adjacent to a built structure, such as balconies, verandas, patios, decks, and porches. By one approach, one or more light sensor arrays, each including one or more light sensors, may be installed within a habitable environment to capture data on lighting conditions within the habitable environment which may be created by direct lighting and/or by reflected or other indirect lighting. Data captured by one or more light sensor arrays may inform building occupants, managers, or owners of building performance with respect to lighting parameters and may also be utilized to improve the health and comfort of one or more occupants of or visitors to one or more spaces within the building. Examples of lighting parameters that may be monitored by one or more of the light sensor arrays include luminous intensity, luminous flux, illuminance (i.e., brightness), energy efficiency, luminance, beam angle, color, and color temperature.

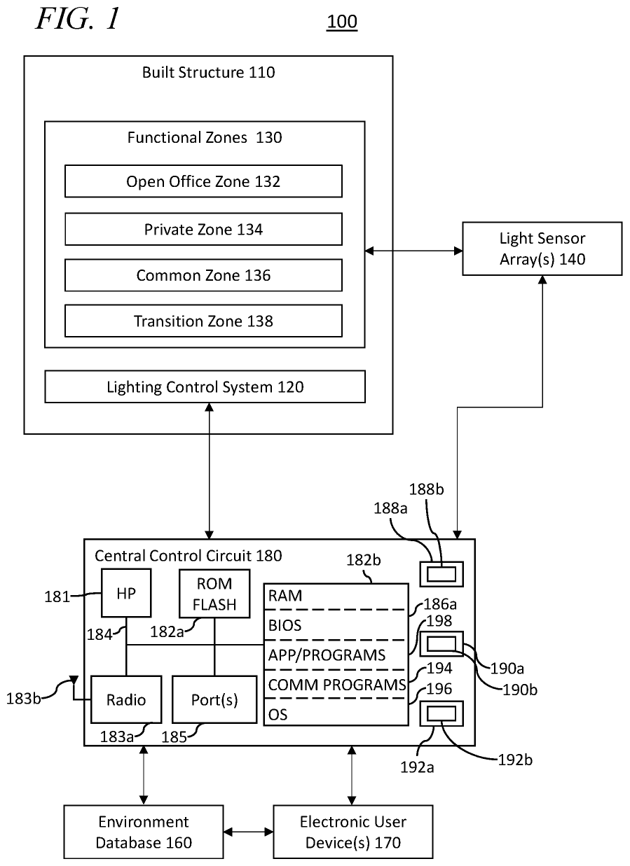

FIG. 1 illustrates a block diagram of an exemplary lighting monitoring system 100 for monitoring one or more lighting parameters in a habitable environment. In some approaches, the lighting monitoring system 100 may be a standalone system for monitoring one or more lighting parameters. In other approaches, the lighting monitoring system 100 may form a part of, or otherwise incorporate, one or more existing lighting systems within a habitable environment. In some embodiments the lighting monitoring system 100 may form part of a home wellness and/or a “smart home” system in the habitable environment, which may also include other systems or components that contribute to or improve a wellness or sense of wellness of an occupant of the habitable environment. For example, embodiments of the lighting monitoring system described herein may be incorporated into systems for enhancing wellness in a habitable environment, an example of which is described in U.S. patent application Ser. No. 15/249,184, which published as US 2017/0053068 on Feb. 23, 2017 and is hereby incorporated by reference for all purposes. Also see U.S. Provisional Patent App. 61/783,718 titled “Systems and Methods for Air Remediation” filed on Dec. 21, 2018 (Attorney Docket Number 20689-143361) and U.S. Provisional Patent App. ______ titled “Systems and Methods for Acoustic Monitoring” filed on Mar. 25, 2019 (Attorney Docket Number 20689-144834) which are incorporated herein by reference in their entireties.

Lighting may affect occupants of a habitable environment in various ways. For example, a well-designed system for monitoring and controlling one or more lighting parameters in a space may positively affect an occupant's mood, sense of well-being, visual comfort, creative thinking ability, and productivity (e.g., by aiding in task performance). Additionally, a well-designed system for monitoring and controlling one or more lighting parameters may reduce construction and/or operating costs for building owners. For example, daylight may be used reduce artificial lighting requirements within a built structure.

Light often influences the human body in a number of ways. Metabolism has been linked to the daily solar cycle through melatonin and the endocrine system. This cycle in the human body is called the circadian rhythm. Humans have an internal clock that keeps the body on an approximately 24-hour cycle which matches the Earth's solar cycle, even in continuous darkness. Multiply bodily processes, from periods of alertness and sleep to digestion efficiency, are partially regulated by the intensity and color of light received by the eyes. Exposure to light comparable to the intensity of direct sunlight will aid in resetting the circadian rhythm if it has been upset by shift work or long-distance travel.

Lighting quality, therefore, is an important aspect of a habitable environment. Capturing data on one or more lighting parameters through sensor technologies is important in order to evaluate a particular habitable environment and also to help provide awareness to one or more occupants or other people of environmental conditions.

Lighting (e.g., illumination) may include electromagnetic radiation or energy with wavelengths in the visible spectrum, near infrared (NIR), and/or near ultraviolet (NUV or UVA) portions of the electromagnetic spectrum. For the purposes of the lighting monitoring system 100, lighting may encompass electromagnetic radiation in the visible spectrum of light, which is typically defined as having wavelengths in the range of about 400 nm to about 700 nm, as well as light of other wavelengths. Additionally, lighting may encompass lighting or illumination from a variety of internal and/or external sources, including both artificial and natural sources. Artificial light sources, for example, may include fluorescent lights, compact fluorescent lights, and incandescent lights light emitting diodes (LEDs). Artificial light sources may take a variety of forms including lamps (e.g., table top, floor standing, wall mounted), sconces, and/or overhead or recessed lighting. Natural light sources may include, for example, the sun. Natural light may be received in the built structure 100 from a variety of sources including, for example, one or more windows, skylights, tubular daylight devices, and/or daylight redirection devices. Whereas illumination may mean artificially created light and lighting may come from any energy source, for the purposes of this application the two are considered interchangeable.

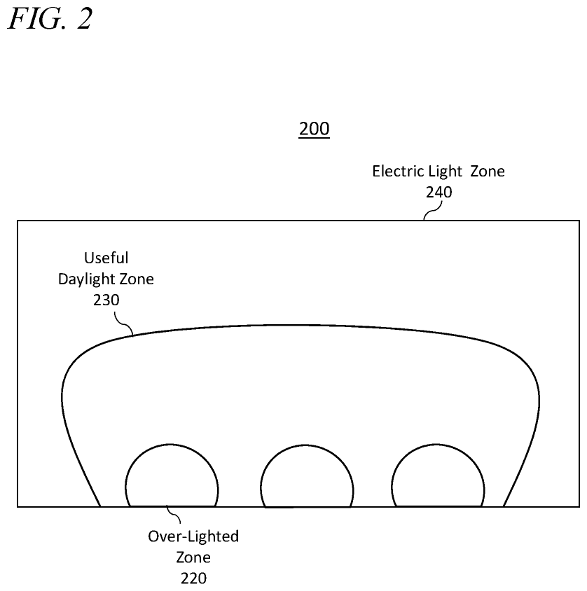

The lighting monitoring system 100 described herein may be associated with or included in a built structure 110. The built structure 110 may include a space or other habitable environment with one or more functional zones 130. By one approach, the functional zones 130 are defined based on normal activities within the built structure. The boundaries of the functional zones 130 may be physical or psychological partitions. Physical partitions may be defined by walls and/or partitions between spaces (e.g., partitions about 1.9 meters from the floor or higher). Psychological partitions may be defined by the normal activities performed by occupants within the space. Psychological partitions, for example, may be defined based on different floorings, different furniture (e.g., desks, tables, couches, beds, chairs), different wall colors, decorations (e.g., artwork, biophilia, mirrors), materials, or surface textures, and/or different appliances (e.g., copy machines, refrigerators, stoves, microwaves, printers, washers, dryers) within the built structure. By one approach, the functional zones 130 may be further subdivided into daylight zones as shown in FIG. 2-4.

By one approach, the built structure 110 may be an enclosed space with an indoor environment where the primary light source is from artificial sources. For example, the built structure may be an office building with indoor office space.

In one exemplary embodiment, the functional zones 130 for an office space may include one or more open office zones 132, private zones 134, common zones 136, and/or transition zones 138. Open office zones 132 may include open spaces within the built structure. By one approach, an open office zone may include a space where workspace partitions are under about 1.9 meters tall. Private zones 134 may include private offices and/or conference rooms. Common zones may include lobbies, kitchens, break rooms, meeting areas, lounges, libraries, and/or copy rooms. Transition zones may include corridors, stairways, and/or hallways. Functional zones 130 may be further subdivided into daylight zones as illustrated in FIGS. 2-4.

The lighting monitoring system 100 may further include a lighting control system 120. Controlled lighting or illumination is an important aspect of achieving desirable environmental characteristics of the habitable environment. The lighting control system 120 may be operated within the built structure 110 to adjust one or more various lighting parameters within the one or more various functional zones. By one approach, the lighting control system may include both an artificial lighting control subsystem and a natural lighting subsystem which may be operated in tandem to provide lighting to the built structure.

In the lighting control system 120, the artificial lighting control subsystem may include a wide variety of artificial illumination sources such as incandescent, florescent, compact florescent, or LED lights, for example. Further, the artificial illumination sources may be selectively controlled to produce a wide variety of artificial lighting conditions. For example, by one approach, the artificial illumination sources may include one or more LED lights or arrays of one or more LED lights that are capable of producing one or more ranges of wavelengths. Thus, the wavelength of the artificial emitted light may be adjusted by varying a drive current supplied to LEDs and light intensity may be adjusted by selectively operating more or less LEDs or by controlling the power supplied to one or more LEDs.

In the lighting control system 120, the natural lighting control system may include a number of components which are controlled to adjust natural light (e.g., sunlight) being received in the built structure via one or more windows. For example, the natural lighting control system may include one or more actuators which are drivingly coupled to control an amount of natural received in the built structure 110 via one or more windows. Actuators may, for example, take the form of an electrical power source coupled to control the transmissivity of one or more electrochromatic window panes or panels. The electrochromatic window panes or panels may be capable of adjusting ranges of wavelengths passed or blocked and the intensity of the lighting passed or blocked. The actuators may also, for example, take the form of an electric motor, solenoid or other element drivingly coupled to control a position of one or more window coverings. Window coverings may, for example, include drapes, curtains, shades, or blackout shades.

As shown in FIG. 1, the lighting monitoring system 100 generally also includes one or more light sensor arrays 140 to measure one or more various lighting parameters. The light sensor array 140 may comprise one or more light sensors (i.e., photodetectors) configured to sense, detect, or otherwise measure one or more lighting parameters in the habitable space or one or more of the zones therein. A light sensor used in the light sensor array may include, for example, photoresistors, photodiodes, and phototransistors.

A light sensor used in a light sensor array 140 may be configured to measure one or more lighting parameters at defined detection intervals, for example, but not limited to, every set number of milliseconds, seconds, minutes, hours, etc. In some approaches the light sensor detection interval is based on the characteristics of light. For example, the light sensor detection interval may be shorter (i.e., monitors more frequently) if light intensity is greater. A higher light intensity may be indicative of daytime hours when more frequent monitoring is desirable. In other approaches, the light sensor detection interval may between about 10 seconds and about 24 hours. In some approaches the light sensor detection interval may be 0.5 minute, 1 minutes, 2 minutes, 3 minutes, 4 minutes, 5 minutes, or other time interval. A light sensor detection interval of 5 minutes, for example, may facilitate convenient data analysis and visualization. Alternatively to a defined detection, in some approaches a light sensor may measure one or more light parameters only upon the occurrence of an event (e.g., the detection of an occupant of a space or zone, the detection of movement of an occupant within a space or zone or between two or more spaces or zones, a minimum change in temperature level, air quality, noise level, or other environmental factor or a space or zone, a spike in energy use associated with as space or zone, etc.).

Examples of lighting parameters that may be monitored by one or more of the light sensor arrays 140 of the lighting monitoring system 100 include luminous intensity, luminous flux, illuminance (i.e., brightness), energy efficiency, luminance, beam angle, color, and color temperature. In some approaches, not all of the light sensor arrays may be capable of measuring or monitoring all of the same lighting parameters.

In addition to light sensor arrays 140, the lighting monitoring system 100 may further include a central control circuit 180. The central control circuit 180 may take the form of a programmed computer or other processor-based system or device. For example, the central control circuit 180 may take the form of or incorporate a conventional mainframe computer, mini-computer, workstation computer, personal computer (desktop or laptop), or handheld computer.

The central control circuit 180 may include one or more processing units 181 (one illustrated), non-transitory system memories 182a-182b (collectively 182) and a system bus 184 that couples various system components including the system memory 182 to the processing unit(s) 181. The processing unit(s) 181 may be any logic processing unit, such as one or more central processing units (CPUs), digital signal processors (DSPs), application-specific integrated circuits (ASICs), field programmable gate arrays (FPGAs), programmable logic controllers (PLCs), etc. Non-limiting examples of commercially available computer systems include, but are not limited to, an 80×86, Pentium, or i7 series microprocessor from Intel Corporation, U.S.A., a PowerPC microprocessor from IBM, a Sparc microprocessor from Sun Microsystems, Inc., a PA-RISC series microprocessor from Hewlett-Packard Company, or a 68xxx series microprocessor from Motorola Corporation. The system bus 184 can employ any known bus structures or architectures, including a memory bus with memory controller, a peripheral bus, and a local bus. The system memory 182 includes non-transitory Flash or read-only memory (“ROM”) 182a and non-transitory random-access memory (“RAM”) 182b. A basic input/output system (“BIOS”) 186a, which can form part of the ROM 182a or RAM 182b, contains basic routines that help transfer information between elements within the controller 180, such as during start-up.

The controller 180 may include a hard disk drive 188a for reading from and writing to a hard disk 188b, an optical disk drive 190a for reading from and writing to removable optical disks 190b, and/or a magnetic disk drive 192a for reading from and writing to magnetic disks 192b. The optical disk 190b can be a CD/DVD-ROM, while the magnetic disk 192b can be a magnetic floppy disk or diskette. The hard disk drive 188a, optical disk drive 190a and magnetic disk drive 192a may communicate with the processing unit 181 via the system bus 184. The hard disk drive 190a, optical disk drive 190a and magnetic disk drive 192a may include interfaces or controllers (not shown) coupled between such drives and the system bus 184, as is known by those skilled in the relevant art. The drives 188a, 190a and 192a, and their associated computer-readable storage media 188b, 190b, 192b, may provide non-volatile and non-transitory storage of computer readable instructions, data structures, program engines and other data for the lighting monitoring system 100. Although controller 180 is illustrated employing a hard disk 188a, optical disk 190a and magnetic disk 192a, those skilled in the relevant art will appreciate that other types of computer- or processor-readable storage media that can store data accessible by a computer may be employed, such as magnetic cassettes, flash memory, digital video disks (“DVD”), Bernoulli cartridges, RAMs, ROMs, smart cards, etc. The hard disk 188b may, for example, store instructions and data for controlling the lighting monitoring system 100, as well as other for components of a home wellness and/or home automation system, for example based on specific aspects or characteristics detected in one or more indoor or partially enclosed spaces or zones therein in the habitable environment, inputs by an occupant or user of the habitable environment, or events expected or occurring in the habitable environment, to lighting parameters in one more indoor or partially enclosed spaces or zones therein to promote the wellness or wellbeing of the occupant(s). Further, the hard disk 188b may also, for example, store instructions and data for instructing the installation of light sensor arrays within a built structure as part of the lighting monitoring system 100.

Program engines can be stored in the system memory 182b, such as an operating system 196, one or more application programs 198, other programs or engines and program data. Application programs 198 may include instructions that cause the processor(s) 181 to automatically generate signals to control various of the other subsystems to achieve various environmental characteristics or scenes in the habitable environment, for example based on one or more aspects, characteristics or attributes of an occupant thereof. Application programs 198 may include instructions that cause the processor(s) 181 to automatically receive input and/or display output via various user operable input/output (I/O) devices such as, for example, panels installed in the habitable environment, handheld mobile devices, kiosks, and the like.

Other program engines (not specifically shown) may include instructions for handling security such as password or other access protection and communications encryption. The system memory 181 may also include communications programs 194, for example, a server for permitting the central control circuit 180 to provide services and exchange data with the lighting monitoring system 100 and, optionally, other subsystems or computer systems or devices via the Internet, corporate intranets, extranets, or other networks (e.g., LANs, WANs), as well as other server applications on server computing systems such as those discussed further herein. The server in the depicted embodiment may be markup language based, such as Hypertext Markup Language (HTML), Extensible Markup Language (XML) or Wireless Markup Language (WML), and operates with markup languages that use syntactically delimited characters added to the data of a document to represent the structure of the document. A number of servers are commercially available such as those from Microsoft, Oracle, IBM and Apple.

While shown in FIG. 1 as being stored in the system memory 182b, the operating system 196, application programs 198, other programs/engines, program data and communications applications (e.g., server, browser) 194 can be stored on the hard disk 188b of the hard disk drive 188a, the optical disk 190b of the optical disk drive 190a and/or the magnetic disk 192b of the magnetic disk drive 192a.

An operator can enter commands and information (e.g., configuration information, data or specifications) via various user operable input/output (I/O) devices, such as, for example, panels installed in the habitable environment, handheld mobile devices, kiosks, and the like, or through other input devices such as a dedicated touch screen or keyboard and/or a pointing device such as a mouse and/or via a graphical user interface. Other input devices can include a microphone, joystick, game pad, tablet, scanner, touch pad, etc. These and other input devices may be connected to one or more of the processing units 181 through an interface such as a serial port interface 185 that couples to the system bus 184, although other interfaces such as a parallel port, a game port or a wireless interface or a universal serial bus (“USB”) can be used. A monitor or other display device may be coupled to the system bus 184 via a video interface, such as a video adapter (not shown). The central control circuit can include other output devices, such as speakers, printers, etc. Alternatively, or in addition, these and other input devices may be connected directly to the lighting control system 120, allowing a user to directly communicate with and/or control the lighting control system 120.

The central control circuit 180 can operate in a networked environment using logical connections to one or more remote computers and/or devices as described above with reference to FIG. 1. For example, the central control circuit 180 can operate in a networked environment using logical connections to one or more other subsystems, one or more server computer systems, associated non-transitory data storage device, or electronic user devices. The server computer system and associated non-transitory data storage device may, for example, be controlled and operated by a facility (e.g., hotel, spa, apartment building, condominium building, hospital, school, shared office) in which the habitable environment is located. Communications may be via wired and/or wireless network architectures, for instance, wired and wireless enterprise-wide computer networks, intranets, extranets, and the Internet. Thus, the central control circuit 180 may include wireless communications components, for example one or more transceivers or radios 183a and associated antenna(s) 183b for wireless (e.g., radio or microwave frequency communications, collected referred to herein as RF communications). Other embodiments may include other types of communication networks including telecommunications networks, cellular networks, paging networks, and other mobile networks.

The lighting monitoring system may also include one or more electronic user devices 170. The electronic user device 170 may be, for example, a smartphone, tablet, a laptop, a mobile phone, a personal digital assistant, a smartwatch, or other wearable computer or smart devices, personal computer devices, or mobile data network connected devices. In some approaches, the electronic user device 170 may be associated with an occupant of the built structure or with a person who inspects or performs maintenance on the built structure (e.g., in the environment database 160).

Further, the lighting monitoring system may also include or have access to an environment database 160. The environment database 160 may be stored, for example on a server, located locally or in the cloud. The environment database 160 may include a profile associated with an occupant of the built structure 110. The profile may include, for example, lighting parameter data associated with an occupant of the built structure. In addition to lighting parameter data, the profile may further include for example, temperature parameter data, sound parameter data, and/or environmental air quality data associated with an occupant. The environment database 160 may further include some or all of, for example, the lighting parameter data collected or obtained by the light sensor arrays 140 installed within the built structure. In the environment database 160, lighting parameter data collected by the light sensor arrays may be associated with particular zones or spaces within the built structure. By some approaches, the environment database may also include data associated with light sensor arrays installed in the habitable environment of the built structure 110, such as location of the light sensor arrays in the built structure, type of light sensor array, and testing protocol associated with the light sensor arrays.

In the lighting monitoring system 100, the central control circuit 180 may be communicatively coupled to the light sensor arrays 140, the lighting control system 120 of the built structure 110, the electronic user device(s) 170, and the environment database 160.

In operation, the central control circuit 180 may be configured to delineate the boundaries of functional zones within the built structure 110. The lighting monitoring system 100 may be configured to divide the built structure 100 into various functional zones based on electronic floor plans and drawings within the environment database 160. In addition, the lighting monitoring system 100 may be configured to divide the built structure 100 into various functional zones based on images or photos of the built structure 110 captured by the electronic user device 170 and uploaded to the environment database 160. Zoning of the habitable environment within the built structure 110 may be utilized to facilitate improved or even optimal or near optimal light sensor placement within the built structure.

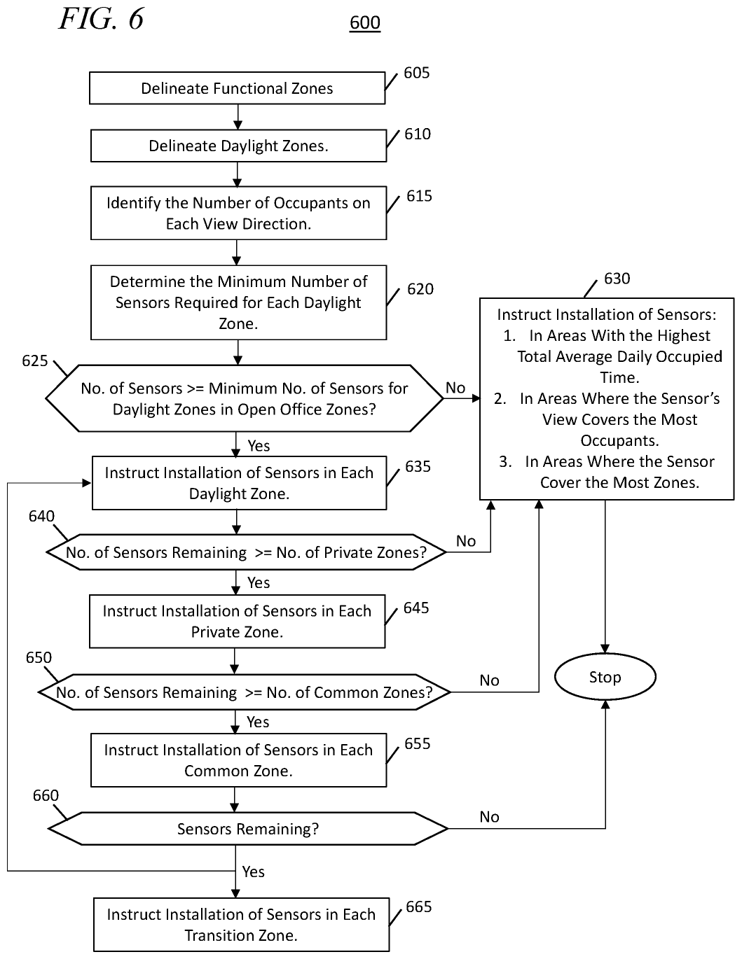

Further, in operation, the lighting monitoring system 100 may instruct the installation of sensor light sensor arrays 140 within the built structure 110 based, in part, on the division of functional zones 130. By one approach, the central control circuit may instruct the installation or operation of one or more light sensor arrays 140 in accordance with the exemplary method detailed in FIG. 6. Additionally, electronic user device(s) 170 may be configured to receive one or more instructions regarding the allocation of or the installation location of one or more light sensor arrays 140 within the built structure. For example, an electronic user device associated with an individual who performs maintenance on the built structure may receive a prioritized list of one or more installation locations for light sensor arrays in the built structure.

After one or more light sensor arrays 140 have been installed, the lighting monitoring system 110 may detect or otherwise monitor one or more lighting parameters within the built structure 100 via the installed light sensor arrays 140. Measured lighting parameters may be compared to values within the environment database 160 to determine whether one or more lighting parameters require adjustment. If a lighting parameter requires adjustment, the central control circuit 180 may send a signal to the lighting control system 120 to make an adjustment. For example, the lighting control system 120 may implement nightlights, employing dim long wavelength LEDs or incandescent luminaries, that engage in response to one or more lighting parameters measured by the light sensor arrays 140.

During operation, the control circuit 180 may send notifications to the user of an electronic user device upon detection of one or more particular measurements or readings by the light sensor arrays 140. For example, the control circuit 180 may send a user of an electronic user device a notification that the user has not been exposed to natural light within a predetermined period of time. In another example, the control circuit may send a user of an electronic device a notification that a particular lighting parameter as measured by a light sensor array in a particular zone within the built structure is outside a preselected range or has been outside a preselected range for a predetermined period of time.

In one embodiment, the control circuit 180 of the lighting monitoring system may send testing instructions for the installed light sensor arrays or for specific light sensor arrays. For example, the environment database 160 may include a testing protocol for the light sensor arrays. The control circuit may send instructions to a user of an electronic user device based on the testing protocol. The user may be, for example, maintenance personnel who perform testing and/or installation of the light sensor arrays. Instructions regarding testing for the light sensor arrays may include the locations of the installed light sensor arrays in the habitable environment. Instructions regarding testing for the light sensor arrays may also include specific steps to calibrate or test the accuracy of light sensor arrays. In some approaches, instructions regarding testing for the light sensor arrays may include a reminder that routine maintenance or testing should be performed based on a testing frequency defined in the environment database.

In some embodiments, the lighting monitoring system may further include one or more occupancy sensors to detect or sense whether the built structure is occupied. The occupancy sensors may be communicatively coupled to the central control circuit to provide signals indicative of whether the built structure is occupied. In response, the lighting monitoring system may begin monitoring and/or adjusting one or more lighting parameters. For example, it may be preferred to only collect data from the light sensor arrays when the built structure is occupied.

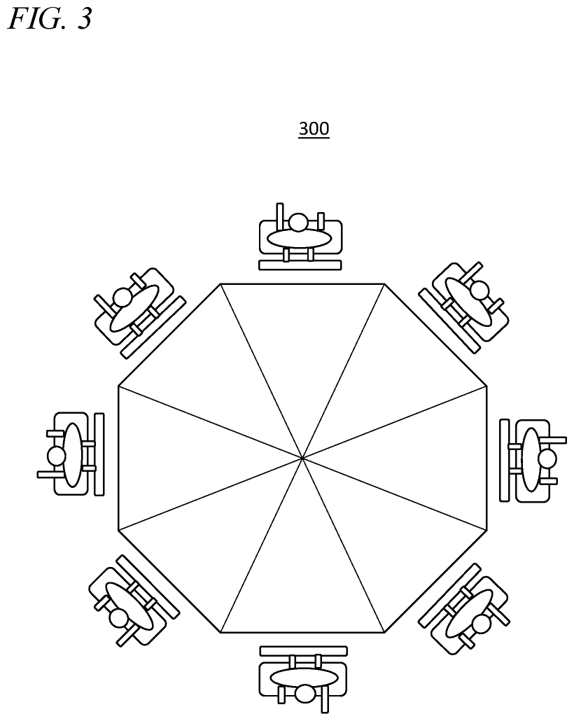

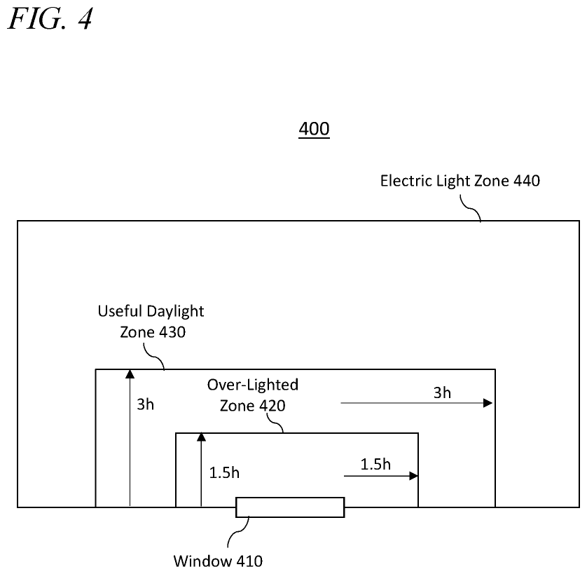

Within the built structure 110, the functional zones 130 may be further sub-divided into daylight zones as shown in FIG. 2 and FIG. 4. The functional zones 130 may be divided into daylight zones based on the daylight distribution within the functional zone. By one approach, daylight distribution within a functional zone may be determined using a computer simulation as illustrated in FIG. 2 and FIG. 3. By another approach, daylight distribution within a functional zone may be determined by offsetting a window frame of the built structure by a certain distance. Further sub-division of functional zones within the built structure 110 may be utilized to facilitate improved or even optimal or near optimal light sensor placement within the built structure as is further detailed in FIG. 6.

FIG. 2 is schematic diagram of daylight zones, identified by computer simulation, within a functional zone in accordance with some embodiments. FIG. 2 shows an example of computer-based daylight simulation results for a functional zone 200. Based on the computer-based daylight simulation results, the functional zone may be divided into different daylight zones. The daylight zones may include at least one of an over-lighted zone 220, a useful daylight zone 230, and an electric light zone 240. Each functional zone may include one or all type(s) of daylight zones.

In FIG. 2, over-lighted zones 220 include the areas where the vertical illuminance (e.g., the amount of light falling on a vertical surface or plane) is greater than about 2,000 lux on the shortest day of the year. Useful daylight zones 230 may include one or more areas where the vertical illuminance is between about 100 lux and about 2,000 lux on the shortest day of the year. Electric light zones 240 include the areas where vertical illuminance is less than about 100 lux on the shortest day of the year.

In one approach, a daylight simulation tool may be used to evaluate the distribution of daylight (e.g., vertical illuminance) in a habitable space within the built structure. Daylight simulation tools provide information on the quantity and quality of daylight within a habitable space, taking into account parameters of the built structure. For example, a daylight simulation tool may allow a user to input files or other data to specify window placement, building layout, interior partitions, and/or material properties as well as time, date, and sky conditions for the simulation. Daylight simulation tools may be used to calculate daylight metrics, such as illuminance or luminance, at various nodes within in the built structure and may display simulation results for each node as numerical values, color images, or contour plots.

By one approach, a daylight simulation may be conducted on the shortest day of the year. The winter solstice may be the shortest day of the year, that is, the day with the shortest period of daylight and the longest night of the year. For the northern hemisphere, the winter solstice occurs in December, usually on December 21st or December 22nd, and is known as the December solstice. For the southern hemisphere, the winter solstice occurs in June, usually on June 20th or June 21st, and is known as the June solstice. On the December solstice, the sun shines directly over the Tropic of Capricorn and, on the June solstice, the sun shines directly over the Tropic of Cancer.

In one approach, daylight simulation may be used to determine useful daylight illuminance, which in turn may be used to delineate daylight zones. Useful daylight illuminance is a metric for daylight availability that corresponds to the percentage of occupied time when a desired range of illuminances is met by daylight at a particular point in a space. For example, useful daylight illuminances may be defined as those illuminances that fall within the range of about 100 lux to about 2,000 lux. Daylight illuminances that fall within the range of about 100 lux to about 2,000 lux are defined as useful. Daylight illuminances below about 100 lux may fall short of the useful range. While daylight illuminances that are greater than about 2,000 lux may exceed the useful range. By some approaches, the high bound for useful daylight illuminance may be between about 2,000 and about 3,000 lux and the low bound for useful daylight illuminance may be between about 100 and about 300 lux.

The vertical illuminance for an occupant within a built structure may vary based on the view direction of the occupant. Because vertical illuminance within a built structure may vary based on the direction of view, computer-based daylight simulations may be conducted for multiple view directions. By some approaches, the computer-based daylight simulation may be conducted for at least eight view directions at each testing node. FIG. 3 is a schematic diagram of possible view directions for an occupant at each node in a built structure in accordance with some approaches for daylight simulation.

If computer-based daylight simulation tools are unavailable, daylight distribution may also be determined by offsetting a window frame a certain distance. FIG. 4 is a schematic diagram of daylight zones delineated within a functional zone in accordance with some approaches. In FIG. 4 exemplary functional zone 400 has been divided into daylight zones by offsetting a window 410 frame a certain distance. The daylight zones include an over-lighted zone 420, a useful daylight zone 430, and an electric light zone 440. By this approach, each functional zone may include one or all type(s) of daylight zones.

By some approaches, the over-lighted zone 420 and useful daylight zone 430 may be delineated by offsetting the window 410 frame a certain distance. For example, the boundary for an over-lighted zone may be defined by offsetting a window frame by a distance of about one to about two times the window height. More specifically, the boundary for an over-lighted zone may be a distance of about 1.5 times the window height.

In FIG. 4, the over-lighted zone 420 includes the area within a distance of 1.5-times the window height (h) from the window frame (i.e., the boundary for the over-lighted zone 420 is located a distance 1.5h from the window frame). Useful daylight zone 430 includes the area between 1.5-times the window height (h) from the window frame and 3-times the window height (h) from the window frame (i.e., the boundary for the useful daylight zone 430 is located a distance of 3h from the window frame). Electric light zone 440 includes the area beyond 3-times the window height (h) from the window frame.

By an alternative approach, daylight illuminance data for a built structure may be obtained by measuring illuminance at various measurement nodes within the habitable space. Daylight illuminance may be measure, for example, by a luxmeter and measurements may be obtained periodically to determine the daylight distribution within the habitable space of the built structure.

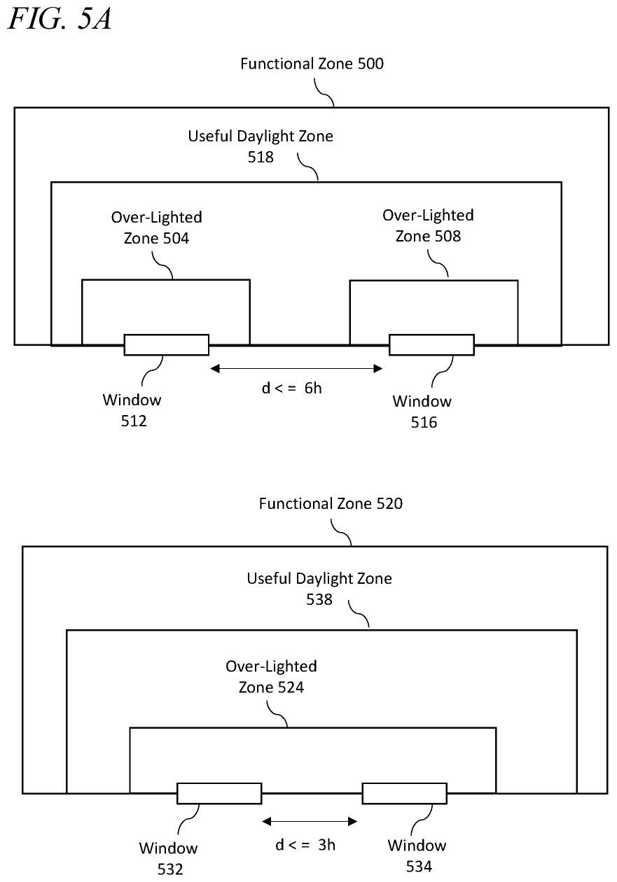

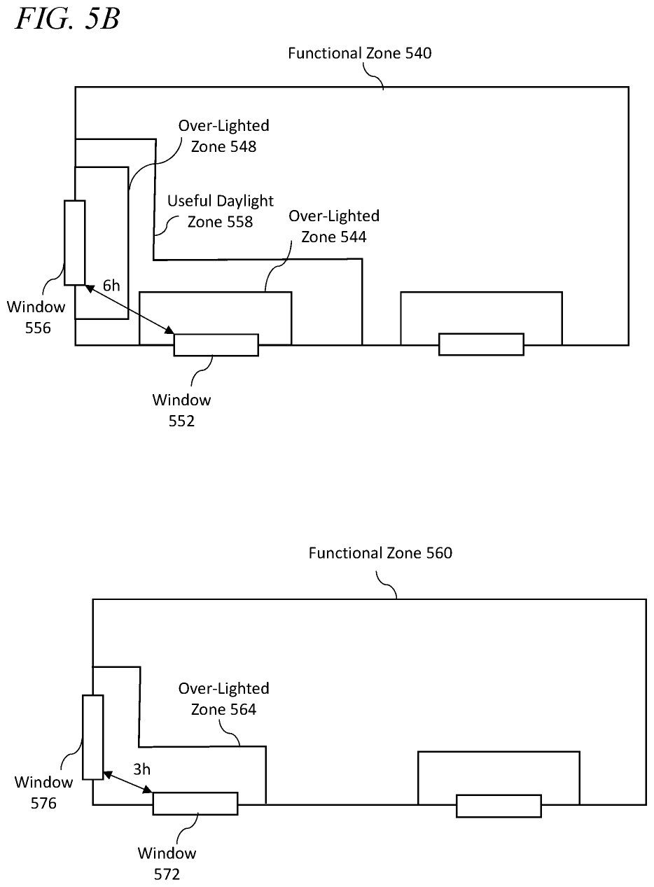

By some approaches, zones may be combined. FIG. 5A illustrates the layout of exemplary functional zones with combined over-lighted zones and combined useful daylight zones. In FIG. 5A, functional zone 500 includes two windows, window 512 and window 514. Window 512 is surrounded by over-lighted zone 504 and window 516 is surrounded by over-lighted zone 508. Similarly, window 512 and window 516 are each also surrounded by a useful daylight zone. As illustrated in FIGS. 2 and 4, the boundary for useful daylight zones may be defined by a distance of three times the window frame height (3h). In functional zone 500, the distance between window 512 and window 516 is less than or equal to six times the window frame height (6h). Because the distance between window 512 and window 516 is less than or equal to times the window frame height, the two useful daylight zones around window 512 and window 516 may be combined into a single useful daylight zone 518.

Further, in FIG. 5A, functional zone 520 includes two windows, window 532 and window 534. Window 532 and window 534 are each surrounded by an over-lighted zone. As illustrated in FIGS. 2 and 4, the boundary for useful daylight zones may be defined by a distance of 1.5 times the window frame height (1.5h). In functional zone 520, the distance between window 532 and window 534 is less than three times the window frame height (3h). Because the distance between window 532 and window 534 is less than three times the window frame height (3h), the over-lighted zones surrounding window 532 and window 534 may be combined into a single over-lighted zone 524. Additionally, because the distance between window 532 and window 534 is less than six times the window frame height (6h), the two useful daylight zones surrounding window 532 and window 534 may be combined into a single useful daylight zone.

FIG. 5B illustrates the layout of an exemplary functional zone with combined over-lighted zones and combined useful daylight zones. Functional zone 540 includes window 552 and window 556, which are installed on perpendicular walls. Window 552 is surrounded by over-lighted zone 544 and window 556 is surrounded by over-lighted zone 548. In functional zone 540, the distance between window 552 and window 556 is greater than six times the window frame height (6h). Because the distance between window 552 and window 556 is greater than 6 times the window frame height (6h), over-lighted zone 544 and over-lighted zone 548 may not be combined. Window 552 and window 556 are also each surrounded by useful daylight zones. Because the distance between window 552 and window 556 is greater than six times the window frame height (6h), the useful daylight zones surrounding window 552 and window 556 may be combined into a single useful daylight zone 558.

Functional zone 560 includes window 572 and window 576, which are on installed on perpendicular walls. Window 572 and window 576 are each surrounded by over-lighted zones. In functional zone 560, the distance between window 572 and window 576 is three times the window frame height (3h). Because the distance between window 572 and window 576 is three times the window frame height (3h), the useful daylight zones surrounding window 572 and window 576 may be combined into a single over-lighted zone 564.

Optimal or near optimal or improved light sensor placement within a habitable environment is important to enhance the performance of systems that monitor lighting parameters. Optimal or near optimal light sensor placement may be dictated by the spatial variations and temporal variations of light within a built structure. Choosing optimal or near optimal installation within a built structure is important for delivering reliable data and constructive feedback for occupants. The placement of sensor arrays within a built structure may affect the readings of sensor arrays and, therefore, may impact the quality of the data collected by sensor arrays.

FIG. 6 illustrates a method of monitoring lighting parameters 600 in a habitable environment in accordance with some embodiments. The method of FIG. 6 may be deployed by the lighting monitoring system 100 or portions thereof as described with reference to FIG. 1. In the method of FIG. 6, the system instructs the installation of sensor arrays at locations within a built structure in order to facilitate optimized monitoring of lighting parameters. To enhance the performance of the lighting monitoring system 100, the system also defines zones within the built structure to determine optimal or near optimal sensor array placement. By one approach, this method is primarily executed by control circuit 180 of lighting monitoring system 100.

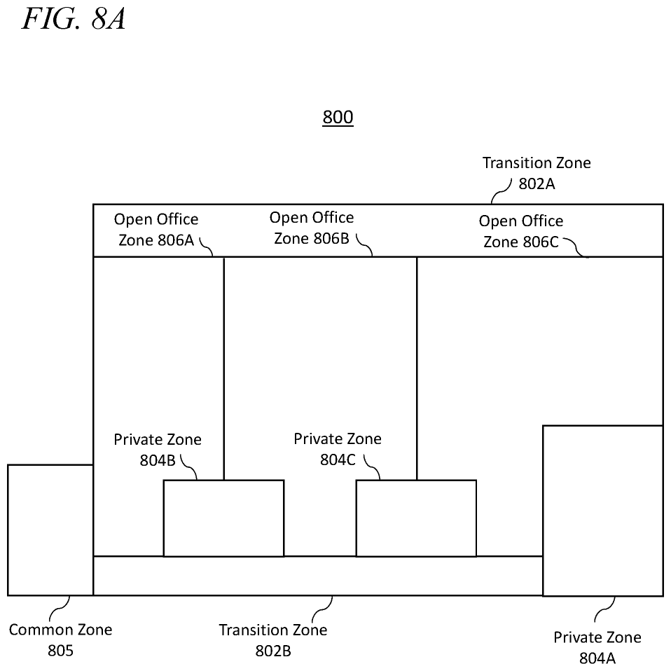

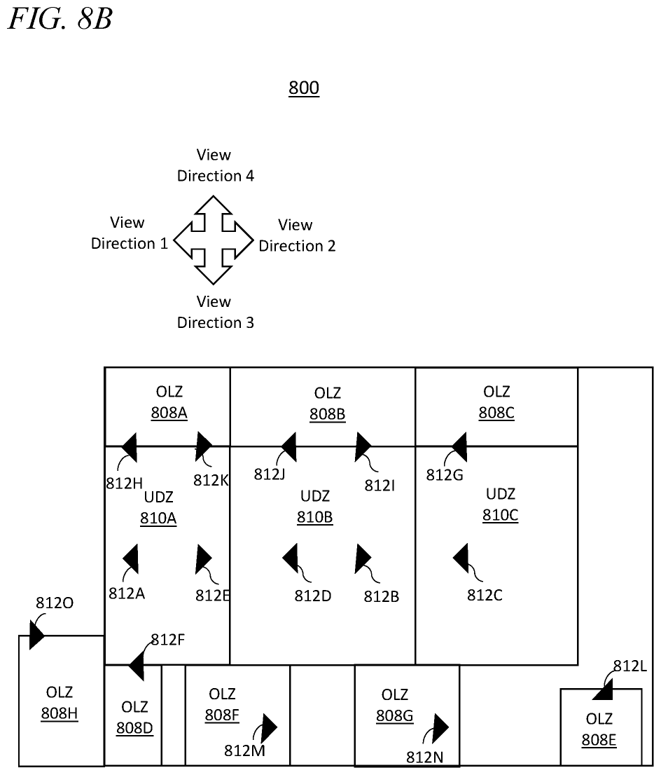

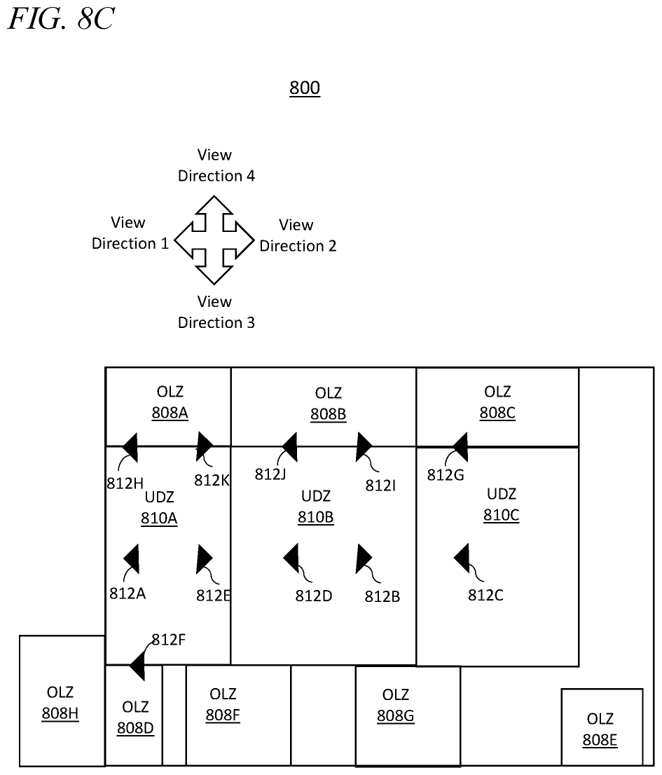

The method of monitoring lighting parameters 600 begins at step 605. At step 605, the system delineates functional zones. Functional zones may be delineated based on the normal activities in various areas of the habitable environment. In an office space, for example, functional zones may include open office zones, private zones, common zones, and transition zones. Functional zones may be delineated based, in whole or in part, on a floor plan detailing the layout of the habitable environment, drawings of the interior layout of the habitable environment, and/or photographs of the habitable environment. By one approach, the boundaries of the functional zones may be delineated by physical or psychological partitions within a habitable environment. Physical partitions may be, for example, by walls and/or partitions between spaces (e.g., partitions about 1.9 meters from the floor or higher). Psychological partitions, for example, may be based on different floorings, different furniture (e.g., desks, tables, couches, beds, chairs), different partition attributes, and/or different appliances (e.g., copy machines, refrigerators, microwaves, printers, washers, dryers) within the built structure. FIG. 8 illustrates the locations of functional zones in an exemplary office space habitable environment.

By one approach, the boundaries of functional zones may be defined based, in whole or in part, on input from occupants of the habitable space. For example, the occupant of a habitable space may compete a survey to select the functionality of various areas of a habitable space, this may include how the occupant uses the various areas a majority of the time. The central control circuit may be configured to delineate psychological partitions within the habitable space based on survey results. In another example, an occupant may select the boundaries for functional zones. Assessments or onsite examinations of the habitable environment may also be used to delineate functional zones at step 605. Occasional assessments of the habitable space may also be used to detect changes in the use and/or layout of the habitable space.

By another approach, the boundaries of functional zones may be based, in whole or in part, on photographs of the habitable environment. Photographs of the habitable environment may be obtained, for example, by occupants of the habitable environment using electronic user devices 170. Photographs of the habitable environment may also be obtained via individuals who occasionally assess or examine the habitable environment.

After delineating functional zones, in some approaches the system may also assign a zone priority to each delineated functional zone at step 605. Zone priority may indicate the order of preference for light sensor array sensor installation among the functional zones. For example, light sensor arrays may be installed a functional zone with high zone priority before they are installed in a functional zone with low zone priority.

Zone priority may be determined based on, for example, the number of occupants located or expected to be located within a functional zone at a specific time, during a specific range of time, averaged over a specific range of time, etc., or the number of fixed seating locations within a functional zone. The number of occupants located within a functional zone may be determined by an occupancy sensor or may be input into the system by a user. In an exemplary office space, such as the exemplary office space illustrated in FIG. 8, the zone priority may be:

Open Office Zones>Private Zones>Common Zones>Transition Zones

Within the same type of functional zone (e.g., within open office zones), the zone with the higher total average daily occupied time should have the higher priority. For example, if two open office zones have the same number of occupants, the open office zone with the higher total average daily occupied time should be assigned the higher zone priority. For zones of the same type, having the same total average daily occupied time, either zone may be selected to have the higher zone priority. Total average daily occupied time may be determined by the following formula:

$$Total Average Daily Occupied Time = ( Average Daily Occupied Time ) \times ( Number of Occupants ) \qquad Formula 1$$

The total daily occupied time is a function of the average daily occupied time. The average daily occupied time is the average number of hours a person spends in a space. A survey completed by occupants, managers, or owners of the habitable space may be used to estimate the average daily occupied time a particular space. ASHREA Standard 90.1-2007 may also be used to estimate average daily occupied time. Another variable that impacts total daily occupied time is the number of occupants in a space. By one approach the number of occupants may be represented by the number of seats within a particular space or the capacity of the space. By another approach the number of occupants within a space may be determined using an occupancy sensor.

For example, an office space may have two conference rooms: conference room A and conference room B. Conference room A has six seats and conference room B has eight seats. The average daily occupied time of conference room A is seven hours and the daily average occupied time for conference room B is five hours. The results for total average daily occupied time using Formula 1 are shown in Table 1.

TABLE 1

| | Average Daily | Number | Total Average |
|---|---|---|---|
| | Occupied | of | Daily Occupied |
| | Time | Occupants | Time |
| Conference Room A | 7 | 6 | 42 |
| Conference Room B | 5 | 8 | 40 |

After step 605, the system may proceed to step 610. At step 610, the system delineates daylight zones within the functional zones. The system may delineate daylight zones within each functional zone or within select functional zones. The system may use a computer-based daylight simulation, as illustrated in FIG. 2, to determine the boundaries for daylight zones. Additionally, the system may offset window frames a certain distance, as illustrated in FIG. 4, to determine the boundaries of daylight zones. Daylight zones may also be delineated based, in whole or in part, on a floor plan detailing the layout of the habitable environment, drawings of the interior layout of the habitable environment, and/or photographs of the habitable environment.

At step 615, the system identifies the number of occupants on each view direction. Step 615 may be completed before, after, or concurrently with steps 605 and 610. By one approach, the number of occupants on a view direction may indicate the number of occupants within a space that are facing a particular direction for a majority of the time spent in the space. For example, eight possible view directions are shown in the schematic diagram in FIG. 3. In an exemplary approach, the number of occupants on each of the eight view directions may be determined by a survey completed by occupants of the habitable space.

After the system identifies the number of occupants on each view direction, at step 620, the system determines the minimum number of light sensor arrays required for each daylight zone. The minimum number of light sensor arrays required for each daylight zone may depend on whether the light sensor arrays are vertically-mounted or horizontally-mounted sensor arrays. Vertically-mounted light sensor arrays are mounted in on vertical planes, such as walls, partitions between workspaces, or other vertical panels. Horizontally-mounted sensor arrays are mounted on horizontal surfaces, such as desk surfaces, tables, cabinet surfaces, shelves, counter surfaces, or ceilings.

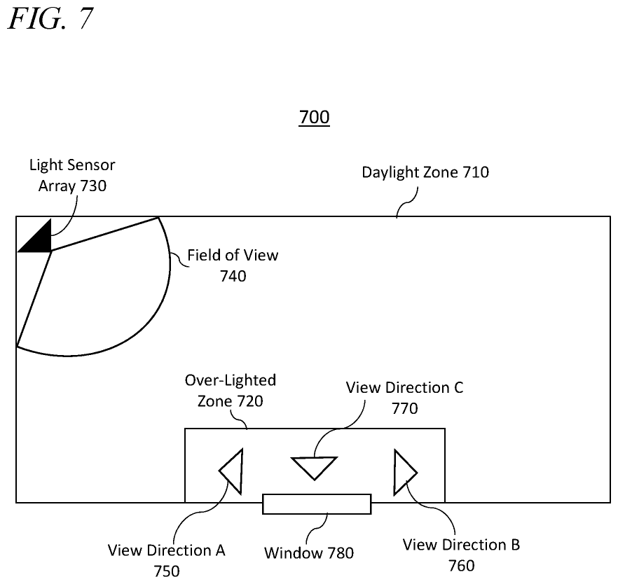

By one approach, if the light sensor arrays are vertically-mounted, the minimum number of light sensor arrays required for each daylight zone may be the minimum number of sensors that are capable of covering a majority (i.e., more than 50%) of the occupants in the daylight zone. For example, FIG. 7 illustrates the installation of a vertically-mounted light sensor array to cover a majority of occupants in an exemplary daylight zone in accordance with some embodiments. By another approach, if the light sensor arrays are horizontally-mounted, then the minimum number of light sensor arrays required for each daylight zone is at least one sensor.

Because the view directions of vertically-mounted light sensor arrays are capable of being set close to human view, the system may be configured to give priority to the installation of vertically-mounted light sensor arrays. Vertically-mounted sensors may be mounted, for example, on walls, vertical panels, or on partitions between workstations. Vertically-mounted sensor arrays may be installed, for example, at a height of about one meter to about 1.5 meters above the floor or, more specifically, at a height of about 1.2 meters above the floor to mimic human view.

After determining the minimum number of light sensor arrays required for each daylight zone, the system proceeds to step 625. At step 625, the system determines whether the number of light sensor arrays available for installation in the habitable space is greater than or equal to the minimum number of light sensor arrays required for the daylight zones in open office zones. The minimum number of sensors required for the daylight zones in open office zones may be determined by adding the number of light sensor arrays required for each daylight zone at step 620 for those daylight zones that are located in open office zones. If the number of light sensor arrays available for installation in the habitable space is greater than or equal to the minimum number of light sensor arrays required for the daylight zones in open office zones, then the system proceeds to step 635. If the number of light sensor arrays available for installation in the habitable space is less than to the minimum number of light sensor arrays required for the daylight zones in open office zones, then the system proceeds to step 630.

At step 635, the system instructs the installation of light sensor arrays in each daylight zone in an open office zone. If the number of light sensor arrays is equal to the minimum number of light sensor arrays required in daylight zones in open office zones, then the process is complete as no light sensor arrays will be available after installation. If there are still light sensor arrays available for installation after a light sensor array has been installed in each daylight zone in an open office zone, then the system proceeds to step 640.

At step 640, the system determines whether the number of light sensors remaining is greater than or equal the number of private zones within the habitable space. To determine whether the number of light sensors remaining is greater than or equal the number of private zones, the system compares the number of light sensor arrays that are still available for installation to the total number of delineated private zones in the habitable space. If the number of light sensors remaining is greater than or equal the number of private zones within the habitable space, then the system proceeds to step 645. If the number of light sensors remaining is less than the number of private zones within the habitable space, then the system proceeds to step 630.

At step 645, the system instructs the installation of light sensor arrays in each private zone. If the number of light sensor arrays available for installation is equal to the number of private zones, then the process is complete as no light sensor arrays will be available after installation. If there are light sensor arrays remaining ager installing a light sensor array in each private zone, then the system proceeds to step 650.

At step 650, the system determines whether the number of light sensor arrays remaining is greater than or equal to the number of common zones within the habitable space. To determine whether the number of light sensors remaining is greater than or equal the number of common zones, the system compares the number of light sensor arrays that are still available for installation to the total number of delineated common zones in the habitable space. If the number of light sensors remaining is greater than or equal the number of common zones within the habitable space, then the system proceeds to step 655. If the number of light sensors remaining is less than the number of common zones within the habitable space, then the system proceeds to step 630.

At step 630, the system instructs the installation of light sensor arrays according to the following priority: in areas with the highest total average daily occupied time first, then in areas where the light sensor array's field of view covers the most occupants, and finally in areas where the light sensor array covers the most zones. In some installations, the options indicated in step 630 may work best in an open plan area, or otherwise in an area with a floor plan that uses large and open spaces and does not use many, if any, small and enclosed rooms or other spaces (e.g., private offices, small meeting rooms).

At step 655, the system instructs the installation of light sensor arrays in each common zone. If the number of light sensor arrays available for installation is equal to the number of common zones, then the process is complete as no light sensor arrays will be available after installation. If there are light sensor arrays remaining ager installing a light sensor array in each common zone, then the system proceeds to step 660.

At step 660, the system determines whether there are still light sensor arrays available for installation in the habitable space. To determine whether there are still light sensor arrays available for installation, they system may subtract the total number of light sensor arrays installed in daylight zones in open office zones and the total number of light sensor arrays installed in private zones and common zones from the total number of light sensor arrays that were available for installation. If there are no light sensor arrays remaining, then the process is complete. If there are light sensor arrays remaining or otherwise available for installation, then they system proceeds to step 665. At step 665, the system instructs the installation of light sensor arrays in each delineated transition zone.

In another embodiment, once the system has determined in which zones light sensor arrays should be installed, the system may also provide instructions with respect to the location and direction in which the light sensor array(s) should be installed within each zone. For example, for vertically-mounted light sensor arrays, it is important that daylight is not obstructed by objects such as high partitions, furniture, plants, walls. Similarly, for horizontally-mounted light sensor arrays, it is important that the sensor view is not obstructed by, for example, ceiling fans, light fixtures, or ductwork. Thus, the central control circuit may be configured to instruct the installation of light sensor arrays where the sensor array field of view is unobstructed based on, for example, photographs, drawings, or floor plans of the habitable environment. Further, for ceiling-mounted horizontally-mounted light sensor arrays it may be desirable to position the light sensor array central to the area illuminated by artificial lighting sources. The central control circuit, therefore, may be configured to instruct the installation of a horizontally-mounted light sensor array at a centralized ceiling location.

With respect to a lighting monitoring system, additional considerations are important for light sensor array installation. For example, other high-frequency transmitters may interfere with the readings of a light sensor array. Thus, the central control circuit may also be configured to instruct installation of light sensor arrays based on the location of other high-frequency transmitters. Additionally, when possible, it may be beneficial to install one or more light sensor arrays near boundaries between over-lighted zones and electric-lighted zones. For example, in an office space it may be beneficial to install one or more light sensor arrays on the workspace closest to boundaries over-lighted zones and electric-lighted zones. Thus, the central control circuit may be configured to instruct the installation of light sensor arrays along boundaries between over-lighted zones and electric-lighted zones.

In addition to light sensor array location, light sensor array orientation (i.e., view direction) is important in order to optimize data collection and monitoring. Specifically, the accuracy of data collected by the light sensor array may be influenced by the incident daylight direction and the view direction of the occupants in a habitable space. It may be beneficial, for example, for a light sensor array to receive light from the same direction and height of human eyes so that the data collected by the light sensor array represents the light received by human eyes. FIG. 7 is schematic diagram of the view direction of a vertically-mounted light sensor array positioned in accordance with some embodiments.

FIG. 7 illustrates a vertically-mounted sensor array installed in an exemplary daylight zone in accordance with some embodiments. Daylight zone 710 has one window 780 and one light sensor array 730 in daylight zone 710. Light sensor array 730 has a field of view 740 of 120 degrees. That is, the angle through with the light sensor array 730 can pick up electromagnetic radiation is 120 degrees. Further, in daylight zone 710, there are nine occupants facing in three different view directions: view direction A 750, view direction B 760, and view direction C 770. In daylight zone 710, four occupants are facing in view direction A 750, four occupants are facing in view direction B 760, and one occupant is facing in view direction C 770. By some approaches, the habitable space of FIG. 7 may optionally include over-lighted zone 720 with nine occupants facing in three different view directions: four occupants facing in view direction A 750, four occupants facing in view direction B 760, and one occupant facing in view direction C 770.

In FIG. 7, this exemplary daylight zone requires one vertically-mounted light sensor array to cover a majority of occupants. Orienting the light sensor array 730 as shown in FIG. 7, view direction C and view direction B are covered by the field of view 740 of the light sensor array. Adding together the total number of occupants on view direction B (five occupants) and view direction C (one occupant), the view of five occupants is covered by light sensor array 730. Therefore, the view direction of 55.6% of occupants, a majority of occupants, are covered by light sensor array 730. In daylight zone 710, a single light sensor array is capable of covering the view direction of a majority of occupants in daylight zone, so the minimum number of light sensor arrays required is one. By some approaches, when the nine occupants are present in over-lighted zone 720, the single light sensor array 730 may also be capable of covering the view direction of a majority of occupants in over-lighted zone 720.

FIGS. 8A, 8B and 8C illustrate an exemplary habitable environment in which light sensor arrays for a lighting monitoring system have been installed in accordance with several embodiments. Exemplary habitable space 800 is an office space. There are a fixed number of vertically-mounted light sensor arrays available for installation in habitable space 800. The available light sensor arrays have been installed in habitable space 800 in accordance with method 600 (as illustrated in FIG. 6).

As shown in FIG. 8A, habitable space 800 has been divided into a total of nine functional zones. Habitable space 800 includes two transition zones: transition zone 802A and transition zone 802B. Habitable space 800 also includes three private zones: private zone 804A, private zone 804B, and private zone 804C. Further, habitable space 800 includes three open office zones: open office zone 806A, open office zone 806B, and open office zone 806C. Finally, habitable space 800 includes one common zone: common zone 805. Among the functional zones, open office zones have the highest priority for the installation of light sensor arrays, private zones have the second highest priority, followed by common zones and transition zones. Within each type of functional zone, priority has been assigned based on the total average daily occupied time for each zone. The priority of functional zones in habitable space 800 is as follows:

Open Office Zone 806A>Open Office Zone 806B>Open Office Zone 806C

Private Zone 804A>Private Zone 804B and Private Zone 804C

Common Zone 805

Transition Zone 802A>Transition zone 802B

The nine functional zones have been further subdivided into eleven daylight zones in accordance with method 600. Habitable space 800 includes three useful daylight zones (UDZs): useful daylight zone 810A, useful daylight zone 810B, and useful daylight zone 810C. Habitable space 800 also includes eight over-lighted zones (OLZs): over-lighted zone 808A, over-lighted zone 808B, over-lighted zone 808C, over-lighted zone 808D, over-lighted zone 808E, over-lighted zone 808F, over-lighted zone 808G, and over-lighted zone 808H. The priority of the daylight zones in habitable space 800 is as follows:

Useful Daylight Zone 810A>Useful Daylight Zone 810B>Useful Daylight Zone 810C

Over-Lighted Zone 808A>Over-Lighted Zone 808B>Over-Lighted Zone 808 C>Over-Lighted Zone 808D

Over-Lighted Zone 808E>Over-Lighted Zone 808F and Over-Lighted Zone 808G

Over-Lighted Zone 808H

Habitable space 800 has a total of thirty occupants. Table 2 shows the number of occupants on each view direction. Because the available light-sensor arrays are vertically mounted, the minimum number of light sensor arrays required is the minimum number of light sensor arrays capable of covering a majority of the thirty occupants. Additionally, the available light sensor arrays have a field of view of 120 degrees.

TABLE 2

| | Functional | | | | |
|---|---|---|---|---|---|
| | Zones | | | | |
| | Covered | View | View | View | View |
| Daylight | by Daylight | Direction | Direction | Direction | Direction |
| Zone | Zone | 1 | 2 | 3 | 4 |
| UDZ 810A | open office | 2 | 2 | 0 | 0 |
| UDZ 810B | open office | 2 | 2 | 0 | 0 |
| UDZ 810 C | open office | 2 | 0 | 0 | 0 |
| OLZ 808A | open office & | 1 | 1 | 0 | 0 |
| | transition | | | | |
| OLZ 808B | open office & | 1 | 1 | 0 | 0 |
| | transition | | | | |
| OLZ 808C | open office & | 1 | 0 | 0 | 0 |
| | transition | | | | |
| OLZ 808D | open office & | 1 | 0 | 0 | 0 |
| | transition | | | | |
| OLZ 808E | private | 4 | 4 | 1 | 0 |
| OLZ 808F | private | 1 | 0 | 0 | 0 |
| OLZ 808G | private | 1 | 0 | 0 | 0 |
| OLZ 808H | common | 0 | 0 | 0 | 0 |

In the approach shown in FIG. 8B, there are a total of fifteen light sensor arrays available for installation in habitable space 800. Because the number of light sensor arrays is greater than the total number of daylight zones in open office zones, light sensor arrays can be installed in each of the seven daylight zones in open office zones (i.e., in OLZ 808A, OLZ 808B, OLZ 808C, UDZ 810A, UDZ 810B, UDZ 810C, and OLZ 808D). The system will instruct the installation of eleven light sensor arrays (812A to 812K) in the seven daylight zines in open office zones. After instructing the installation of light sensor arrays in all of the daylight zones in open office zones, four of the fifteen light sensor arrays are still available for installation. Next, the system prioritizes the installation of light sensor arrays in private zones. There are a total of three private zones and four light sensor arrays available for installation. Thus, the system may instruct the installation one light sensor array in each private zone, as illustrated in FIG. 8B. For over-lighted zone 808E, light sensor array 812L can cover both view direction two and view direction three to cover a total of five occupants as shown in FIG. 8B. Thus, the system may instruct the installation of one light sensor array in over-lighted zone 808E. After instructing the installation of light sensor arrays in each private zone, there is still one light sensor array remaining. The system will give common zones priority after daylight zones in open office zones and private zones. The last light sensor array 8120, therefore, may be installed in common zone 805, which is covered by daylight zone 808H.

In an alternative approach, there are only eleven light sensor arrays available for installation in habitable space 800. A light sensor array may be installed in each daylight zone in an open office zone as illustrated in FIG. 8C.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

1. An apparatus for sheltering occupants comprising:
a built structure having a habitable environment;
a plurality of light sensor arrays configured to measure one or more lighting parameters;
a central control circuit communicatively coupled to the light sensor arrays, the control circuit configured to:
delineate a plurality of functional zones in a built structure based on an electronic floor plan;
after delineation of the functional zones, delineate each functional zone into daylight zones based on daylight distribution;
identify a number of occupants on each view direction in each daylight zone;
determine a minimum number of light sensor arrays required for open office daylight zones based on spatial requirements of the light sensor arrays and the number of occupants on each view direction in each daylight zone; and
instruct the installation of at least one light sensor array in the delineated open office zones;
wherein if a total number of light sensor arrays available for installation is less than a sum of the minimum number of light sensor arrays required for the open office daylight zones, then the installation of light sensor arrays occurs based on an identified order of preference.

2. The apparatus of claim 1 wherein the plurality of functional zones includes at least one open office zone, private zone, common zone, or transition zone.

3. The apparatus of claim 1 wherein the daylight zones include at least one over-lighted zone, useful daylight zone, or electric light zone.

4. The apparatus of claim 1 wherein the identified order of preference is areas having the highest total average daily occupied time first, then areas where the light sensor arrays cover the most occupants, and then areas where the light sensor arrays cover the most zones.

5. The apparatus of claim 4 wherein if the total number of light sensor arrays available for installation is greater than or equal to the sum of the minimum number of light sensor arrays required for the open office daylight zones, then at least one light sensor array is installed in each daylight zone.

6. The apparatus of claim 5 wherein, after installing at least one light sensor array in each daylight zone, if the number of light sensor arrays available for installation is less than the number of private zones, light sensor array installation occurs according to the following order of preference: areas having the highest total average daily occupied time first, then areas where the light sensor arrays cover the most occupants, and then areas where the light sensor arrays cover the most zones and if the number of light sensor arrays available for installation is greater than or equal to the number of private zones, then at least one light sensor array is installed in each private zone.

7. The apparatus of claim 6 wherein, after installing at least one light sensor in each private zone, if the number of light sensor arrays available for installation is less than the number of common zones, light sensor array installation occurs according to the following order of preference: areas having the highest total average daily occupied time first, then areas where the light sensor arrays cover the most occupants, and then areas where the light sensor arrays cover the most zones and if the number of light sensor arrays available for installation is greater than or equal to the number of common zones, then at least one light sensor array is installed in each common zone.

8.-13. (canceled)

14. The apparatus of claim 1 wherein upon installing light sensor arrays in areas where the light sensor arrays cover the most zones, installation occurs in the following order of preference: open office zones first, then private zones, then common zones, and then transition zones.

15. A method for monitoring lighting in a habitable environment, the method comprising:
delineating a plurality of functional zones in a built structure based on an electronic floor plan;
delineating each functional zone into daylight zones based on daylight distribution;
determining a minimum number of light sensor arrays required for open office daylight zones based on spatial requirements of the light sensor arrays and a number of occupants on each view direction in each daylight zone;
instructing the installation of at least one light sensor array in at least one of the delineated open office daylight zones; and
operating a lighting system according to readings from the light sensor arrays in the delineated functional zones;
wherein if a total number of light sensor arrays available for installation is less than a sum of the minimum number of light sensor arrays required for the open office daylight zones, then the installation of light sensor arrays occurs based on an identified order of preference.

16. The method of claim 15 wherein the plurality of functional zones includes at least one open office zone, private zone, common zone, or transition zone.

17. The method of claim 15 wherein the daylight zones include at least one over-lighted zone, useful daylight zone, or electric light zone.

18. The method of claim 15 wherein the identified order of preference is areas having the highest total average daily occupied time first, then areas where the light sensor arrays cover the most occupants, and then areas where the light sensor arrays cover the most zones.

19. The method of claim 15 wherein determining a minimum number of light sensor arrays required for the open office daylight zones based on spatial requirements of the light sensor arrays and a number of occupants on each view direction in each daylight zone comprises:
identifying the field of view of each light sensor array;
identifying possible view directions of each light sensor array in the open office daylight zone;
totaling the number of occupants on each possible view direction within the field of view of each light sensor array; and
determining a minimum number of light sensor arrays wherein the total number of the number of occupants on the possible view directions of the light sensor arrays is greater than 50 percent of occupants.

20. The method of claim 15 further comprising instructing the installation of at least one light sensor array in a private zone, common zone, or transition zone.

21. The method of claim 17 wherein the over-lighted zone is an area where the vertical illuminance is over about 2,000 lux on the shortest day of the year or is an area within about 1.5 times a height of window frame offset lines.

22. The method of claim 17 wherein the useful daylight zone is an area where the vertical illuminance is between about 100 lux and about 2,000 lux on the shortest day of the year or is an area between about 1.5 and about 3 times a height of window frame offset lines.

23. The method of claim 17 wherein the electric light zone is in an area where the vertical illuminance is less than 100 lux on the shortest day of the year or is an area beyond about 3 times the height of the window frame offset lines.

24. The method of claim 15 wherein the functional zones are delineated by physical partitions within a built structure that are about 1.9 meters tall or higher.

25. (canceled)

26. The method of claim 15 wherein the light sensor arrays are vertically-mounted sensors mounted on partitions, walls, or other vertical panels about 1.2 meters about the floor.

27. The method of claim 15 wherein the light sensor arrays are installed close to a boundary of an over-lighted zone or a boundary of an electric-light zone.

28.-48. (canceled)
